(19) United States
(12) Patent Application Publication
(10) Pub. No.: US 2025/0097740 A1
(43) Pub. Date: Mar. 20, 2025

(54) INFORMATION PROCESSING DEVICE

(71) Applicant: TOYOTA JIDOSHA KABUSHIKI KAISHA, Toyota-shi (JP)

(72) Inventors: Katsuhiro MATSUOKA, Nagakute-shi (JP); Ryo TAMURA, Toyota-shi (JP); Hidenori AKITA, Toyota-shi (JP)

(73) Assignee: TOYOTA JIDOSHA KABUSHIKI KAISHA, Toyota-shi (JP)

(21) Appl. No.: 18/822,656

(22) Filed: Sep. 3, 2024

(30) Foreign Application Priority Data
Sep. 19, 2023 (JP) 2023-151060

(51) Int. Cl. H04W 24/04; H04W 76/18

(52) U.S. Cl. CPC H04W 24/04; H04W 76/18

(57) ABSTRACT

An information processing device installed in a vehicle that includes a first communication module for performing communication with a cellular communication network, a second communication module for performing communication among vehicles, and a control unit that executes receiving, from one or more other vehicles via the second communication module, communication state data relating to a state of communication with the cellular communication network, and determining whether a failure is occurring on the cellular communication network, based on a state of communication via the first communication module, and the communication state data.

### CROSS-REFERENCE TO RELATED APPLICATION

This application claims priority to Japanese Patent Application No. 2023-151060 filed on Sep. 19, 2023, incorporated herein by reference in its entirety.

### BACKGROUND

### 1. Technical Field

The present disclosure relates to communication technology.

### 2. Description of Related Art

Technology has been developed to detect failures occurring in cellular communication networks. In regard to this, Japanese Unexamined Patent Application Publication No. 2009-169629 (JP 2009-169629 A), for example, discloses a device for relaying and transmitting emergency notification information by inter-vehicle communication means, as alternative notification means when communication via a cellular communication network cannot be performed.

### SUMMARY

An object of the present disclosure is to detect a failure occurring on a cellular communication network.

An aspect of an embodiment of the present disclosure provides information processing device that is installed in a vehicle, the information processing device including a first communication module for performing communication with a cellular communication network a second communication module for performing communication among vehicles, and a control unit that executes receiving, from one or more other vehicles via the second communication module, communication state data relating to a state of communication with the cellular communication network, and determining whether a failure is occurring on the cellular communication network, based on a state of communication via the first communication module, and the communication state data.

Also, examples of other aspects include a method executed by the above device, a program for causing a computer to execute the method, and a computer-readable storage medium storing the program in a non-transitory manner.

According to the present disclosure, a failure occurring on a cellular communication network can be detected.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of a vehicle communication system according to a first embodiment;

FIG. 2 is a hardware configuration diagram of the in-vehicle device 10;

FIG. 3 is a software configuration diagram of the in-vehicle device 10;

FIG. 4 is an example of broadcast data to be broadcast;

FIG. 5A is a flow chart of processing executed by an in-vehicle device 10;

FIG. 5B is a flow chart of processing executed by an in-vehicle device 10; and

FIG. 6 is a schematic diagram of a vehicle communication system according to a second embodiment.

### DETAILED DESCRIPTION OF EMBODIMENTS

In recent years, the connectivity of automobiles has advanced, and the number of vehicles equipped with an in-vehicle device having a wireless communication function has increased. The in-vehicle device can provide various services to the occupant of the vehicle by communicating with a server device (an application server or the like) via a cellular communication network (also referred to as a mobile telephone network or a mobile communication network), for example.

However, in such a system, when a failure occurs in the cellular communication network, all communication becomes impossible. Further, since the means for notifying the occurrence of the failure itself is also lost, it is not possible to notify the occupant of the vehicle that the communication failure has occurred.

The information processing device according to the present disclosure solves such a problem by estimating that a failure occurs in a cellular communication network by using a communication unit other than the cellular communication network.

An information processing device according to a first aspect of the present disclosure includes: information processing device that is installed in a vehicle, the information processing device including a first communication module for performing communication with a cellular communication network a second communication module for performing communication among vehicles, and receiving, from one or more other vehicles via the second communication module, communication state data relating to a state of communication with the cellular communication network, and determining whether a failure is occurring on the cellular communication network, based on a state of communication via the first communication module, and the communication state data. A control unit for executing the program is provided.

The first communication module is a communication module for communicating with a cellular communication network (mobile communication network). The first communication module is also referred to as a cellular communication module. The second communication module is a communication module for performing communication between vehicles via a network other than the cellular communication network. The second communication module may typically be a communication module for performing inter-vehicle communication (or V2X communication). Communication between vehicles may be by a peer-to-peer network in which the vehicles transmit and receive data directly.

The control unit receives communication state data from another vehicle via the second communication module. The communication state data is data indicating a state of communication with the cellular communication network, and is typically data including a communication status, a measurement value related to communication, and the like. The communication state data received from another vehicle may be stored in a storage device (storage unit).

The control unit can determine whether or not a failure has occurred in the cellular communication network based on the state of communication via the first communication module and the communication state data received from the other vehicle. For example, when the host vehicle falls into a state in which communication cannot be performed via the first communication module, it is possible to estimate whether or not a failure has occurred in the cellular communication network by referring to the communication state data received from another vehicle.

According to such a configuration, information on the cellular communication network can be collected by means other than the cellular communication network. Thus, even when a state in which the cellular communication network cannot be used occurs, it is possible to estimate whether the failure is in the cellular communication network itself or whether communication cannot be performed due to other factors.

When the cellular communication cannot be performed, the control unit may generate communication state data by itself and broadcast the communication state data via the second communication module. This makes it possible to provide information to other vehicles.

The determination as to whether or not a failure has occurred in the cellular communication network may be made by aggregating the number of other vehicles that cannot normally communicate with the cellular communication network. For example, when a predetermined ratio or more of the plurality of other vehicles located in the vicinity is non-communicable, it can be estimated that a failure has occurred in the cellular communication network. When the host vehicle is not in the service area of the cellular communication network, the determination may not be performed.

Hereinafter, embodiments of the present disclosure will be described with reference to the drawings. A hardware configuration, a module configuration, a functional configuration, etc., described in each embodiment are not intended to limit the technical scope of the disclosure to them only unless otherwise stated.

### First Embodiment

### System Overview

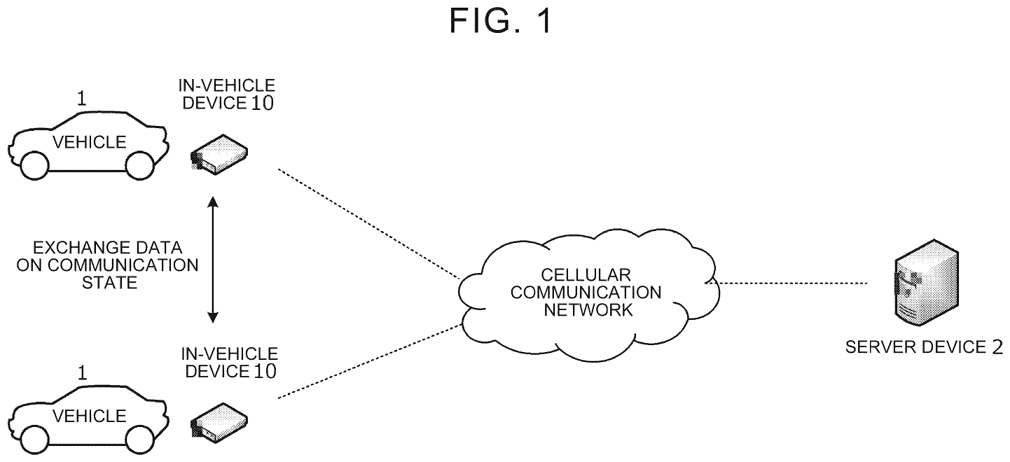

An outline of the vehicle communication system according to the first embodiment will be described with reference to FIG. 1. The vehicle communication system according to the present embodiment includes a plurality of vehicles 1 and an in-vehicle device 10 installed in the vehicle 1. The in-vehicle device 10 is connected to a predetermined server device 2 via a cellular communication network. The system may include a plurality of vehicles 1 and a plurality of server devices 2.

The vehicle 1 is a connected vehicle capable of communicating with an arbitrary server device by wireless communication. The vehicle 1 can provide various services by performing communication with an external server device (for example, the server device 2) via the in-vehicle device 10 having a cellular function. Examples of the various services include a navigation service, a remote control (e.g., remote air conditioning) service, an in-vehicle Wi-Fi (registered trademark) service, and an emergency notification service. In addition to the illustrated devices, the vehicles 1 may include components (for example, an ECU, an in-vehicle terminal, and the like) that provide these services.

The in-vehicle device 10 is a device that communicates with a predetermined network in order to connect a component (for example, an ECU, an in-vehicle terminal, or the like) of the vehicle 1 to the server device 2. In the present embodiment, the in-vehicle device 10 is configured to be connectable to a predetermined cellular communication network. The in-vehicle device 10 may be configured to include an Embedded Universal Integrated Circuit Card (eUICC) for identifying a user in a cellular communication network. eUICC may be a physical SIM card, an eSIM, or the like.

In the illustrated example, the in-vehicle device 10 is configured to be capable of communicating with a cellular communication network. The cellular communication network includes a base station, a control device that manages a mobile communication terminal, and the like.

As shown in the drawing, in a mode in which the in-vehicle device 10 communicates with another server device via a cellular communication network, communication is interrupted when a communication failure occurs in the cellular communication network. For example, when a failure occurs in the radio access network, radio waves from the base station may not be captured. In addition, when a failure occurs in the core network, communication with the Internet may be interrupted. However, in the case where communication via the cellular communication network fails, the in-vehicle device 10 alone cannot determine whether there is a cause in the cellular communication network (for example, whether a communication failure has occurred) or a cause (for example, in its own device).

In order to cope with this, in the present embodiment, the plurality of in-vehicle devices 10 generate and broadcast data related to the state of communication with the cellular communication network, and the other in-vehicle devices 10 that have received the data accumulate the data. As a result, the in-vehicle device 10 can grasp “whether another vehicle located in the vicinity is able to normally communicate with the cellular communication network”, and can estimate the presence or absence of a communication failure based on this. In the following description, the communication failure means that communication via the cellular communication network cannot be performed normally due to a failure occurring in the radio access network or the core network.

The in-vehicle device 10 is equipped with a first communication module for performing communication with a cellular communication network and a second communication module for performing inter-vehicle communication. The in-vehicle device 10 can exchange data regarding a state of communication with the cellular communication network between the vehicles via the second communication module. The second communication module can adopt any communication standard as long as it can perform communication between vehicles. Preferably, the second communication module uses a standard capable of broadcasting data.

### Hardware Configuration

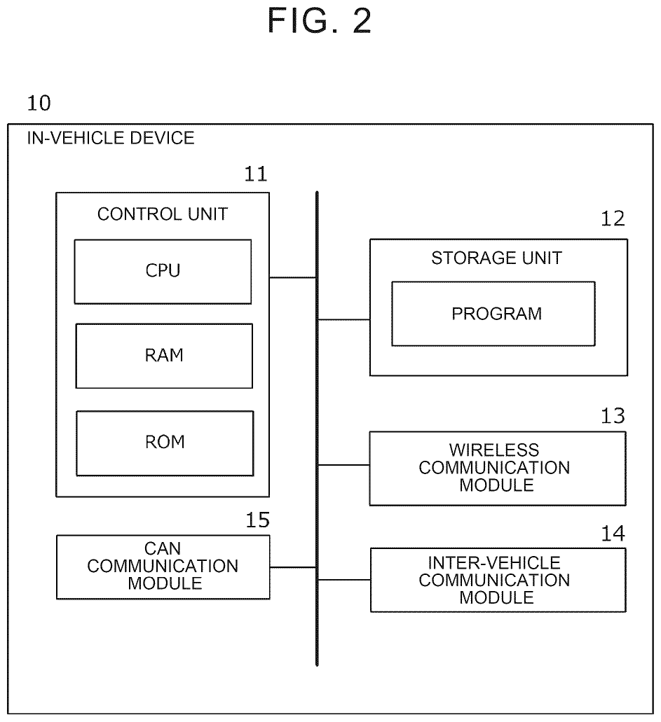

Next, a hardware configuration of each device constituting the system will be described. FIG. 2 is a diagram schematically illustrating an example of a configuration of hardware included in the in-vehicle device 10 according to the present embodiment.

The in-vehicle device 10 can be configured as a computer including a processor (a central processing unit (CPU), a graphics processing unit (GPU), and the like), a main storage device (a random access memory (RAM), a read only memory (ROM), and the like), an auxiliary storage device (an erasable programmable read only memory (EPROM), a hard disk drive, a removable medium, and the like). The secondary storage device stores an operating system (OS), various programs, various tables, and the like. By executing the program stored in the auxiliary storage device, it is possible to realize each function (software module) that matches a predetermined purpose, as will be described later. However, some or all of the functions may be realized as a hardware module by hardware circuitry such as Application Specific Integrated Circuit (ASIC), Field Programmable Gate Array (FPGA), or the like.

The in-vehicle device 10 includes a control unit 11, a storage unit 12, a wireless communication module 13, an inter-vehicle communication module 14, and a CAN communication module 15.

The control unit 11 is an arithmetic unit that realizes various functions of the in-vehicle device 10 by executing a predetermined program. The control unit 11 can be realized by, for example, a hardware processor such as a CPU. The control unit 11 may include a RAM, ROM, a cache memory, and the like.

The storage unit 12 is a unit that stores information, and is configured by a storage medium such as a RAM, a magnetic disk, or a flash memory. The storage unit 12 stores a program executed by the control unit 11, data used by the program, and the like.

The wireless communication module 13 is a communication device that performs wireless communication with a predetermined network. In the present embodiment, the wireless communication module 13 is configured to be capable of communicating with a predetermined cellular communication network. The wireless communication module 13 may be configured with an eUICC (e.g., a SIM card). SIM card is configured as a microcomputer including a CPU and a storage device. SIM card is connected to a cellular communication network and stores information to be authenticated.

The inter-vehicle communication module 14 is a communication device for performing wireless communication between vehicles. The inter-vehicle communication module 14 can perform communication using, for example, a frequency band assigned to be dedicated to ITS. The in-vehicle device 10 can communicate with the in-vehicle device 10 installed in another vehicle via the inter-vehicle communication module 14. The communication standard used by the inter-vehicle communication module 14 may be one-to-one communicable or may be capable of broadcasting arbitrary data.

The Controller Area Network (CAN) communication module 15 is a communication interface for connecting the in-vehicle device 10 to an in-vehicle network of the vehicle 1. CAN communication module 15 may be configured to include, for example, a network interface that performs communication according to CAN protocol. The in-vehicle device 10 can perform data communication with other components (for example, an ECU, an in-vehicle terminal, or the like) of the vehicle 1 via CAN communication module 15.

### Software Configuration

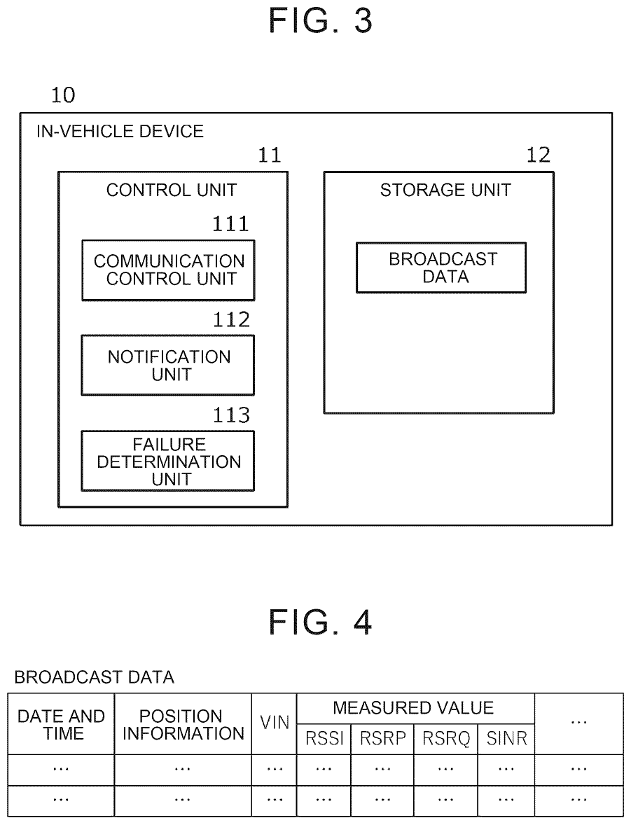

Next, the software configuration of each device constituting the system will be described. FIG. 3 is a diagram schematically illustrating a software configuration of the in-vehicle device 10 according to the present embodiment.

In the present embodiment, the control unit 11 included in the in-vehicle device 10 includes three software modules: a communication control unit 111, a notification unit 112, and a failure determination unit 113. The software modules may be implemented by executing programs stored in the storage unit 12 by a control unit 11 (CPU or the like). Note that the information processing executed by the software module is synonymous with the information processing executed by the control unit 11 (CPU or the like).

The communication control unit 111 establishes a network connection with the outside of the vehicle in response to a request from a vehicle component included in the vehicle 1. For example, the communication control unit 111 receives a connection request to a specific server device (for example, the server device 2) from a vehicle component included in the vehicle 1, and establishes a communication path to the server device 2 in response to the connection request. The communication control unit 111 may establish a connection to the cellular communication network by using a built-in SIM card or the like and maintain the connection. The communication control unit 111 may establish a communication path to the server device 2 by using the established connection. Furthermore, the communication control unit 111 relays data transmitted and received between the vehicle component and the server device 2.

The notification unit 112 generates data related to a state of communication with the cellular communication network, and periodically broadcasts the data toward another vehicle. The data generated and transmitted by the notification unit 112 is hereinafter referred to as notification data. The notification data is an example of “communication state data”. For example, the notification unit 112 measures one or more numerical values related to the quality of the cellular communication, generates broadcast data including the numerical values, and broadcasts the broadcast data.

FIG. 4 is a diagram illustrating a configuration of notification data. As shown in the figure, the notification data includes fields of date and time, position information, Vehicle Identification Number (VIN), and measurement value. The date and time field is a field in which the date and time at which the notification data is generated is stored. The position information field is a field in which data (latitude, longitude, and the like) representing the position of the vehicle 1 is stored. VIN field is a field in which an identifier for uniquely identifying the vehicle in which the notification data is generated is stored.

The measurement value is a numerical value related to the quality of the cellular communication. In the present embodiment, the following items are exemplified as measurement values.

### Received Signal Strength Indicator (RSSI)

Received power of radio waves transmitted from the base station [dBm]

### Reference Signal Received Power (RSRP)

Received power in the reference band [dBm]

### Reference Signal Received Quality (RSRQ)

Index [dB] indicating the quality of the received reference signal

### Signal-to-Interference-plus-Noise Ratio (SINR)

Out of the received signals, the power ratio of the desired signal to the other signals [dB]

Here, four items described above, i.e., the measurement value related to the state of the radio wave, as long as it can be determined whether communication with the cellular communication network is normally performed, the measurement value may include other values. Examples of such a value include a packet-loss rate and a response-rate (ping). The notification unit 112 periodically generates and broadcasts such notification data. The notification data broadcasted by the notification unit 112 is received by the in-vehicle device 10 of another vehicle and accumulated.

When an instruction is given from the communication control unit 111, the failure determination unit 113 executes a process of determining whether or not a failure has occurred in the cellular communication network by using the notification data received from another vehicle. For example, the communication control unit 111 issues the above-described instruction and causes the failure determination unit 113 to perform the above-described processing in a case where communication with the cellular communication network becomes impossible normally. As described above, the broadcast data broadcast from the other vehicle is accumulated in the storage unit 12 of the in-vehicle device 10. By referring to this data, it is possible to determine whether the surrounding vehicle is in a state in which communication cannot be performed, or whether only the host vehicle is in a state in which communication cannot be performed for some reason. On the basis of this, it is possible to determine that a failure has occurred in the cellular communication network.

The determination as to whether or not a failure has occurred in the cellular communication network can be made based on, for example, the following.
(A) Of the other vehicles, a number equal to or larger than a predetermined ratio is in a non-communicable state
   For example, when more than half of the vehicles located in the vicinity are in a non-communicable state, it can be determined that a failure has occurred in the cellular communication network.
(B) The measured value indicating the abnormal value is matched with the vehicle in the other vehicle
   Depending on the type of failure, different phenomena may occur, such as “the strength of the radio wave from the base station falls” or “the strength of the radio wave is high but the packet cannot be transmitted”. Therefore, among the measurement values included in the notification data, those indicating the abnormal value are extracted. Here, when the same measurement value indicates an abnormal value in the host vehicle and the other vehicles, it can be determined that a failure has occurred in the cellular communication network.
(C) The time at which the non-communicable state occurred is matched between the vehicle and the other vehicle
   For example, when it is recorded that both the own vehicle and the other vehicle are in a non-communicable state at a certain time, it can be determined that a failure has occurred in the cellular communication network at the time.
(D) Non-communicable in the service area of the cellular communication network
   When non-communicable occurs in the service area of the cellular communication network, it can be determined that a failure has occurred in the cellular communication network.

When it is determined that a communication failure has occurred, the failure determination unit 113 can execute an action (recovery action) for coping with the failure. For example, the failure determination unit 113 may notify the occupant of the vehicle that there is a service that cannot be used due to the communication failure. The recovery action may be information provision for recovering communication. For example, in a case where an alternative communication path other than a communication carrier in which a communication failure has occurred can be used, a method of using the alternative communication path and a method of setting up the alternative communication path may be guided to an occupant of the vehicle. For example, the communication module may be replaced with a communication module of another communication carrier to provide guidance to the effect that communication becomes possible, or to provide guidance to the effect that communication becomes possible using tethering.

### Flowchart

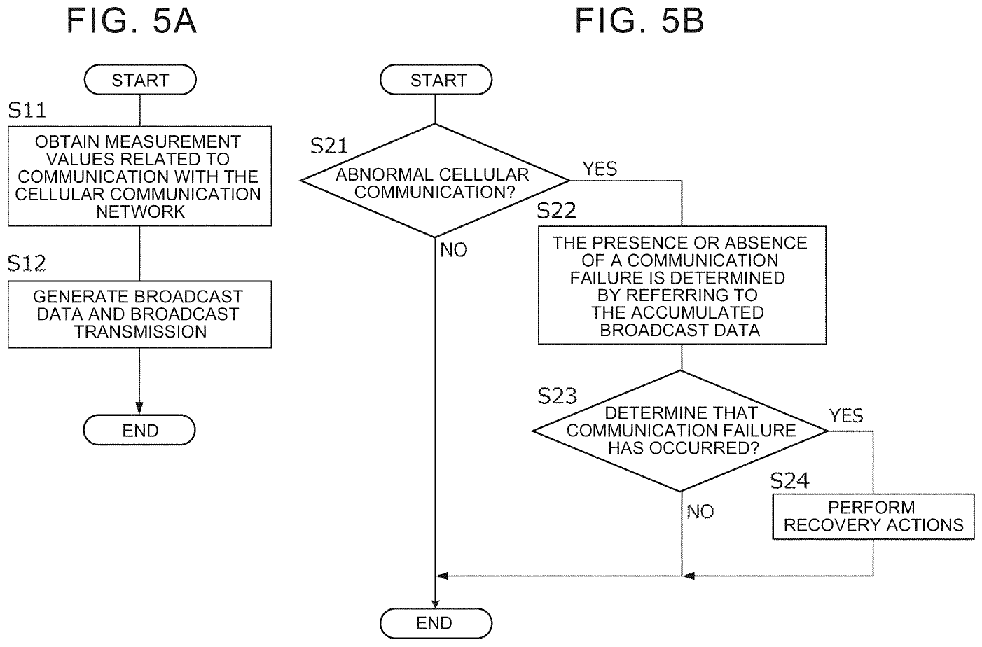

Next, details of processing executed by the in-vehicle device 10 will be described. FIG. 5A is a flowchart of a process in which the in-vehicle device 10 generates and broadcasts notification data, and FIG. 5B is a flowchart of a process in which the in-vehicle device 10 determines a failure of the cellular communication network based on the received notification data. The processes illustrated in FIGS. 5A and 5B are executed periodically.

A process of broadcasting broadcast data will be described. First, in S11, the notification unit 112 acquires one or more measurements related to communication with the cellular communication network. The measurement value may be measured in layers 1, 2, and 3 in a protocol stack of cellular communication, for example. Next, in S12, the notification unit 112 generates notification data including the acquired measurement value and broadcasts the notification data. The notification data is received by another vehicle 1 existing within a predetermined range centered on the vehicle 1.

Next, a process of determining a failure of the cellular communication network will be described. First, in S21, the communication control unit 111 determines whether or not an abnormality has occurred in communication via the cellular communication network. For example, when the throughput is continuously lower than the predetermined value, the communication control unit 111 determines that an abnormality has occurred in communication via the cellular communication network. Further, for example, when the response time from the server exceeds the predetermined value, the communication control unit 111 determines that an abnormality has occurred in communication via the cellular communication network. Further, for example, in a case where a correct response from the server cannot be obtained, the communication control unit 111 determines that an abnormality has occurred in communication via the cellular communication network. When an abnormality occurs in communication via the cellular communication network, the communication control unit 111 instructs the failure determination unit 113 to make a determination regarding a failure, and causes the process to transition to S22. If no abnormality has occurred in the communication via the cellular communication network, the process ends.

In S22, the failure determination unit 113 refers to the notification data accumulated in the storage unit 12 and determines whether or not a failure has occurred in the cellular communication network. In this step, an evaluation value representing a likelihood that a communication failure has occurred may be calculated, and the determination may be performed based on the evaluation value. The likelihood can be calculated, for example, based on the following criteria.
(Reference 1) The larger the number of other vehicles in which an abnormality has occurred in communication with the cellular communication network, the larger the likelihood
(Reference 2) The larger the number of other vehicles in which the same evaluation value as an evaluation value indicating an abnormality in the vehicle indicates an abnormality, the larger the likelihood
(Reference 3) A time at which a certain evaluation value starts to indicate an abnormality is determined, and the likelihood is increased as the number of other vehicles in which the same evaluation value starts to indicate an abnormality after the time is increased

Due to the freshness of the information, the notification data received earlier than a certain period of time may not be used for the determination in S22. For example, notification data that has been received for five minutes or more may not be used for determination.

In addition, a weight may be given to the measurement value in accordance with the elapsed time since the notification data was received. For example, a larger weight may be given to the measurement value as the elapsed time from the reception of the notification data becomes shorter, and a smaller weight may be given to the measurement value as the elapsed time from the reception of the notification data becomes shorter. When the host vehicle is not in the service area of the cellular communication network, the likelihood calculation (determination of the presence or absence of a failure) itself may not be performed.

Here, when the calculated likelihood exceeds a predetermined threshold value, it can be determined that a failure has occurred in the cellular communication network.

Here, the presence or absence of a failure is determined by comparing the likelihood with the threshold, but the presence or absence of a failure may be determined by other conditions. For example, a ratio to the total number of other vehicles that cannot normally communicate with the cellular communication network may be calculated, and when the ratio exceeds a predetermined value, it may be determined that a failure has occurred in the cellular communication network. The total number may be the number of vehicles in which communication is established, or may be the number of vehicles estimated to be within a predetermined range centered on the host vehicle.

If it is determined that a failure has occurred in the cellular communication network (S23—Yes), the process transitions to S24. If it is not determined that a failure has occurred in the cellular communication network, the process ends.

In S24, the recovery action is executed according to the determination result. The recovery action is an action for coping with a communication failure, and includes, for example, a notification that a communication failure has occurred, guidance of an alternative communication means, and the like. For example, when a new communication line can be secured by inserting a communication module of another carrier into the in-vehicle device, the method may be guided.

Further, as one of the recovery actions, the failure determination unit 113 may notify the other vehicle that “the own vehicle has determined that a failure has occurred in the cellular communication network”. For example, the notification data to be transmitted after the next time, it may include the outcome of the determination performed by S22.

When the calculated likelihood is less than the predetermined value (S23—No), it is presumed that the communication cannot be performed due to a failure other than the failure of the cellular communication network. In this case, since a failure of the in-vehicle device 10 is suspected, information for guiding a support window such as a call center may be output.

As described above, in the vehicle communication system according to the first embodiment, each of the plurality of vehicles exchanges data related to the state of communication with the cellular communication network, and when the communication failure is suspected, the presence or absence of the communication failure is determined using the data. According to such a configuration, it is possible to share information for determining the occurrence of a communication failure between vehicles, and it is possible to improve the accuracy of the failure occurrence detection.

### Modification 1 of First Embodiment

In the first embodiment, broadcast data is periodically broadcast from the normal time, each vehicle accumulates this, when the communication failure is suspected, the communication failure is determined using the accumulated broadcast data. However, broadcast of broadcast data may be performed only when a communication failure is suspected. In this case, the fact that the notification data is not received from the other vehicle means that the cellular communication is normally performed in the other vehicle.

In this modification, for example, prior to executing S22, the notification unit 112 generates and broadcasts the notification data. When notification data is not received from another vehicle, it is not determined that a communication failure has occurred, but when the notification data is gradually accumulated, the same determination as in the first embodiment is performed.

### Modification 2 of First Embodiment

In the first embodiment, the notification data is transmitted and received between vehicles by inter-vehicle communication, but the notification data may be transmitted and received by a communication unit other than inter-vehicle communication, such as V2X communication via infrastructures.

For example, when the in-vehicle device 10 has a communication module for performing road-to-vehicle communication, the in-vehicle device 10 may transmit notification data to a roadside unit, and the roadside unit may transmit notification data to other vehicles. The roadside unit may retransmit notification data received from an arbitrary vehicle to another vehicle, or may generate statistical data based on notification data received from a plurality of vehicles, and transmit the generated statistical data to another vehicle. The statistical data may indicate, for example, a ratio of a vehicle in which communication is not normally performed to the entire vehicle. In addition, the statistical data may indicate statistics of measurement values measured by the respective vehicles. The other vehicle can recognize that a communication abnormality has occurred in the other vehicle based on the statistical data.

### Second Embodiment

In the first embodiment, the in-vehicle device 10 determines the presence or absence of a failure in the cellular communication network based on only the notification data received from another vehicle. On the other hand, in a case where there is a plurality of communication carriers, there is a case where the other vehicle that has received the broadcast data is capable of cellular communication. For example, it is a case where a failure occurs in the communication carrier A and communication can be normally performed in the communication carrier B. In this case, there is a case where the vehicle capable of using the communication carrier B transfers the received notification data to an external server device, so that the determination regarding the occurrence of the failure can be performed with high accuracy.

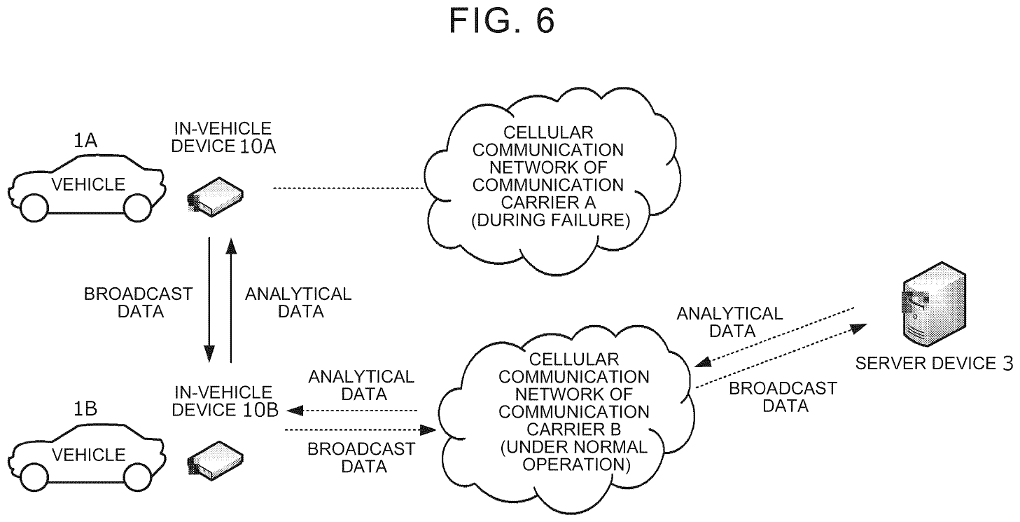

FIG. 6 is a schematic diagram of a vehicle communication system according to a second embodiment. The vehicle 1A includes an in-vehicle device 10A that performs communication via a communication carrier A. The vehicle 1B includes an in-vehicle device 10B that performs communication via a communication carrier B.

Here, it is assumed that a failure has occurred in the communication carrier A. The vehicle 1A (in-vehicle device 10A) broadcasts the notification data by the methods described in the first embodiment, and the vehicle 1B (in-vehicle device 10B) receives the broadcast data. Since the in-vehicle device 10B can perform cellular communication via the communication carrier B, the notification data transmitted from the in-vehicle device 10A can be transferred to an external server device (referred to as the server device 3). In this way, the server device 3 can collect the notification data transmitted from the vehicle affected by the failure via the communication carrier B.

Note that the broadcast data in the second embodiment may include an identifier for identifying a communication carrier. In addition, the in-vehicle device 10B may transmit the notification data to the server device 3 when the notification data having the identifier of the communication carrier other than the communication carrier used by the own device is received.

The server device 3 performs analysis on the collected notification data, and generates a result (analysis data). The analysis data may indicate a likelihood that a failure has occurred in the communication carrier A. Further, the analytical data may be data for assisting the determination performed by the vehicle 1A. The analytical data is transmitted to the vehicle 1B via the communication carrier B and reaches the vehicle 1A via inter-vehicle communication.

As described above, according to the second embodiment, it is possible to transmit the result of the analysis performed by the server device 3 to the vehicle 1A, and thereby it is possible to more accurately determine the failure in the vehicle 1A.

In the above-described example, the server device 3 generates the analysis data using the notification data, but the server device 3 may acquire other data or may generate data other than the analysis data. For example, the server device 3 may acquire the failure information from the device associated with the communication carrier A, and transmit the failure information to the vehicle 1B and the vehicle 1A instead of the analytical data. In addition, the server device 3 may notify the device associated with the communication carrier A when the occurrence of a failure is suspected in the communication carrier A.

Further, when determining that a failure has occurred in the communication carrier A, the server device 3 may pay out the authentication information (SIM profile) that can be temporarily used in the alternative communication carrier. In the exemplary embodiment of FIG. 6, the server device 3 may pay out a SIM profile that can be temporarily used in the communication carrier B, and transmit SIM profile to the vehicle 1A through the vehicle 1B. SIM profile may be, for example, a SIM profile that is available with a deadline. According to such a configuration, an alternative communication path can be provided to the vehicle 1A.

### Modification

The above-described embodiments are merely examples, and the present disclosure may be appropriately modified and implemented without departing from the scope thereof. For example, the processes and means described in the present disclosure can be freely combined and implemented as long as no technical contradiction occurs.

Further, in the description of the embodiment, each vehicle has transmitted the broadcast data to the other vehicle by broadcast, the broadcast data may be transmitted by other means as long as the broadcast communication.

Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. Non-transitory computer-readable storage media include, for example, any type of disk, such as a magnetic disk (floppy disk, hard disk drive (HDD), etc.), optical disk (CD-ROM, DVD disk, Blu-ray disk, etc.). The non-transitory computer readable storage medium also includes a read only memory (ROM), a random access memory (RAM), an EPROM, an EEPROM, a magnetic card, a flash memory, an optical card, and any other type of media suitable for storing electronic instructions.

What is claimed is:

1. An information processing device that is installed in a vehicle, the information processing device comprising:
a first communication module for performing communication with a cellular communication network;
a second communication module for performing communication among vehicles; and
a control unit that executes
receiving, from one or more other vehicles via the second communication module, communication state data relating to a state of communication with the cellular communication network, and
determining whether a failure is occurring on the cellular communication network, based on a state of communication via the first communication module, and the communication state data.

2. The information processing device according to claim 1, wherein the control unit stores the communication state data received from the other vehicles in a storage unit, and when an abnormality occurs in communication via the first communication module, performs determination based on the communication state data that is stored.

3. The information processing device according to claim 1, wherein, when an abnormality occurs in communication via the first communication module, the control unit generates the communication state data and broadcasts the communication state data via the second communication module.

4. The information processing device according to claim 1, wherein the control unit
calculates a proportion of a plurality of the other vehicles that is currently not performing normal communication with the cellular communication network, based on the communication state data received from the other vehicles, and
determines that a failure is occurring on the cellular communication network, when the proportion exceeds a predetermined value.

5. The information processing device according to claim 1, wherein the control unit
calculates a proportion of a plurality of the other vehicles that is currently not performing normal communication with the cellular communication network, based on the communication state data received from the other vehicles, and
determines that a failure is occurring on the cellular communication network, when an own vehicle is in a service range of the cellular communication network, and the proportion exceeds a predetermined value.
